(19) United States
(12) Patent Application Publication
(10) Pub. No.: US 2024/0154459 A1
(43) Pub. Date: May 9, 2024

(54) ASSEMBLY AND METHOD FOR COMBINATION SWITCH AND WIRELESS CHARGER

(71) Applicant: Raffel Systems, LLC, Germantown, WI (US)

(72) Inventors: Justin R. Saul, Milwaukee, WI (US); Bailey Schuetz, Germantown, WI (US)

(21) Appl. No.: 17/983,900

(22) Filed: Nov. 9, 2022

(51) Int. Cl. H02J 50/00; H01H 9/02; H01H 13/70

(52) U.S. Cl. CPC H02J 50/005; H01H 9/0271; H01H 13/70

(57) ABSTRACT

A switch and wireless charging assembly comprising: a platform movable with respect to a center axis between a first position and a second position; a wireless charging assembly coupled to the platform; and a switch activated in response to the platform moving to the second position.

### BACKGROUND

Furniture includes auxiliary functions that are activated with the push of a button. Auxiliary functions include control of powered (e.g., electronically, pneumatically, hydraulically, etc.) actuators that move furniture component parts; light sources, heat sources, massagers, and other accessories.

### SUMMARY

The disclosure provides, in one aspect, an assembly comprising a platform movable with respect to a center axis between a first position and a second position; a wireless charging assembly coupled to the platform; and a switch activated in response to the platform moving to the second position.

In some embodiments, the wireless charging assembly is configured to wirelessly charge a device, and the switch is configured to activate an auxiliary function.

In some embodiments, the first position is an at-rest position, and the second position is a deflected or rotated position.

In some embodiments, the platform is aligned with the center axis when in the first position.

In some embodiments, the platform including a first surface and a recess formed in the first surface that partially receives the wireless charging assembly.

In some embodiments, the platform includes a second surface with an actuation portion extending from the second surface, the actuation portion is aligned with the switch.

In some embodiments, the assembly further includes a case, wherein the platform, the wireless charging assembly, and the switch are at least partially received within the case.

In some embodiments, the case includes a recess formed in a top surface, and an aperture formed in the recess. The actuation portion extends through the aperture.

In some embodiments, the platform is movable with respect to the center axis between the first position, the second position, and a third position, and wherein the switch is a first switch, and the assembly further includes a second switch, and the second switch is activated by the platform in response to the platform moving to the third position.

In some embodiments, the assembly further includes a button cover at least partially covering the platform and the wireless charging assembly.

The disclosure provides, in one aspect, an assembly comprising: a case including a recess formed in a top surface. The recess includes a plurality of apertures. The assembly further includes a platform including a plurality of actuation portions. The plurality of actuation portions extend through the plurality of apertures. The assembly further includes a wireless charging assembly coupled to the platform, and a switch assembly including a plurality of switches. Each of the plurality of actuation portions is configured to actuate one of the plurality of switches.

In some embodiments, the wireless charging assembly includes a coil and a circuit board.

In some embodiments, the assembly further includes a button cover, wherein the wireless charging assembly is positioned between the platform and the button cover.

In some embodiments, the assembly further includes a bezel with an aperture, wherein the bezel is coupled to the case, and the button cover is received within the aperture.

In some embodiments, the platform includes a first surface and a second surface opposite the first surface, wherein the first surface includes a recess formed that partially receives the wireless charging assembly, and wherein the plurality of actuation portions extends from the second surface.

In some embodiments, the platform further includes a stop extending from the second surface, wherein the stop is configured to abut a surface of the recess in response to deflection or movement of the platform.

In some embodiments, the stop is positioned radially outward from the plurality of actuation portions.

In some embodiments, the recess of the case includes a center portion with a center aperture, and the plurality of apertures are spaced around the center aperture.

In some embodiments, the platform includes an anchor received through and coupled to the center aperture.

In some embodiments, the platform is movable between a plurality of positions, wherein each of the plurality of switches is activated in response to the platform moving to one of the plurality of positions.

The disclosure provides, in one aspect, a piece of furniture comprising an adjustable portion configured to move, an actuator coupled to the adjustable portion, and an assembly including a user interface, a wireless charging assembly, and a switch to activate the actuator.

In some embodiments, the user interface includes a button associated with the switch, and wherein the user interface includes a wireless charging interface.

The disclosure provides, in one aspect, a method comprising positioning a user device on a user interface; wirelessly charging the user device; manually actuating a portion of the user interface; and activating an auxiliary function of furniture in response to manually actuating the portion of the user interface.

In some embodiments, activating the auxiliary function includes controlling an actuator, a light source, a heat source, or a massager.

In some embodiments, wirelessly charging the user device occurs simultaneously with manually actuating the portion of the user interface.

Other aspects of the disclosure will become apparent by consideration of the detailed description and accompanying drawings.

### BRIEF DESCRIPTION OF THE DRAWINGS

FIG. 1 is a perspective view of a switch and wireless charging assembly, shown in an at-rest position.

FIG. 2 is a perspective view of the switch and wireless charging assembly of FIG. 1, shown in an actuated position.

FIG. 3 is a perspective view of the switch and wireless charging assembly of FIG. 1, shown with a user device wirelessly charging.

FIG. 4 is a perspective view of a cross-section of the switch and wireless charging assembly of FIG. 1.

FIG. 5 is an exploded view of the switch and wireless charging assembly of FIG. 1.

FIG. 6 is side view of the switch and wireless charging assembly of FIG. 1, with portions removed for clarity.

FIG. 7 is an enlarged partial perspective view of a cross-section of the switch and wireless charging assembly of FIG. 1.

Before any embodiments are explained in detail, it is to be understood that the invention is not limited in its application to the details of construction and the arrangement of components set forth in the following description or illustrated in the following drawings. The invention is capable of other embodiments and of being practices or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The term “coupled,” as used herein, is defined as “connected,” although not necessarily directly, and not necessarily mechanically. The term coupled is to be understood to mean physically, magnetically, chemically, electrically, or otherwise coupled, connected or linked and does not exclude the presence of intermediate elements between the coupled elements absent specific contrary language.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

In the description of some embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “top” and “bottom”, “front” and “rear”, “inner” and “outer”, “above”, “below”, “upper”, “lower”, “vertical”, “horizontal”, “upright” and the like are used as words of convenience to provide reference points.

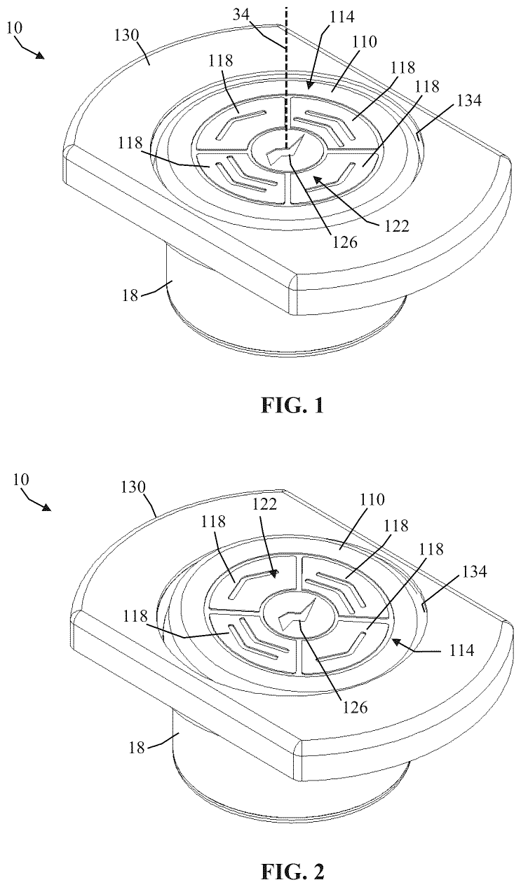

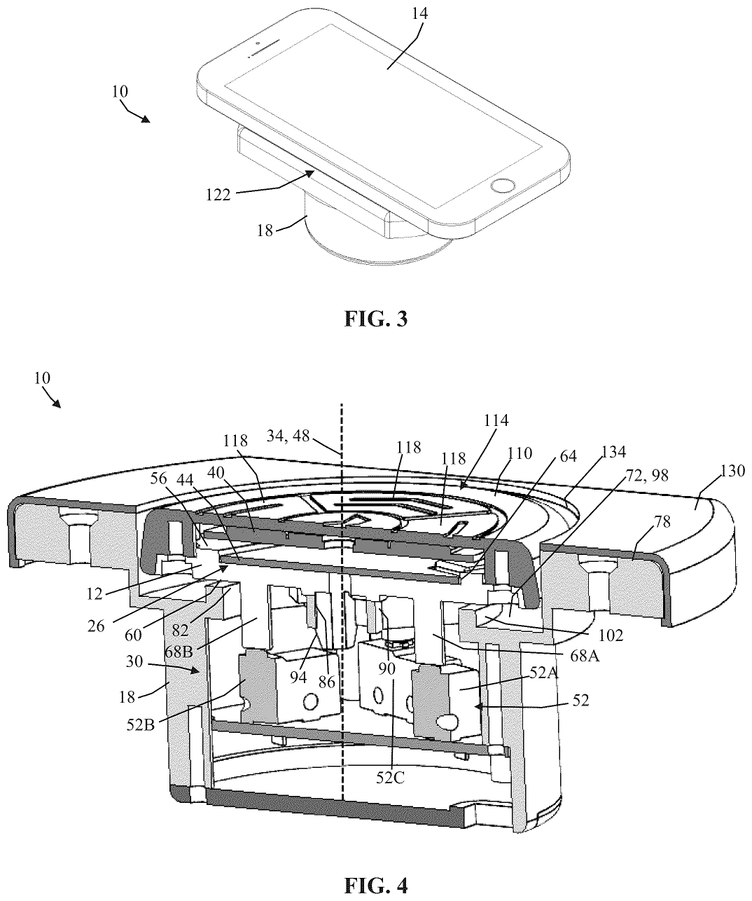

With reference to FIG. 1, a switch and wireless charger combination assembly 10 (“an assembly”) is illustrated. The assembly 10 is configured to be manually actuated by a user (e.g., FIG. 2) to energize a switch or actuator. The assembly 10 is also configured to wirelessly charge a user device 14 (e.g., a cell phone) (FIG. 3). As detailed herein, the assembly 10 thereby incorporates different functions (e.g., button actuation and wireless charging) into a single assembly. As such, the assembly 10 incorporates dual functionality into an efficient compact use of space. In the illustrated embodiment, the assembly 10 provides means to combine a wireless charging platform and a switch assembly for the control of accessories or auxiliary functions.

In some embodiments, the assembly 10 is integrated with a piece of furniture, for example, a piece of powered motion furniture. For example, in one embodiment, the assembly is part of a piece of powered motion furniture and switches control the actuators. Examples of motion furniture are detailed in U.S. patent application Ser. No. 16/776,029 and U.S. patent application Ser. No. 17/211,322; the entire contents of which are incorporated herein by reference in their entirety. In other embodiments, the assembly 10 is integrated with a piece of furniture with an auxiliary function (e.g., lights, heat, massage, etc.) and switches control the auxiliary function.

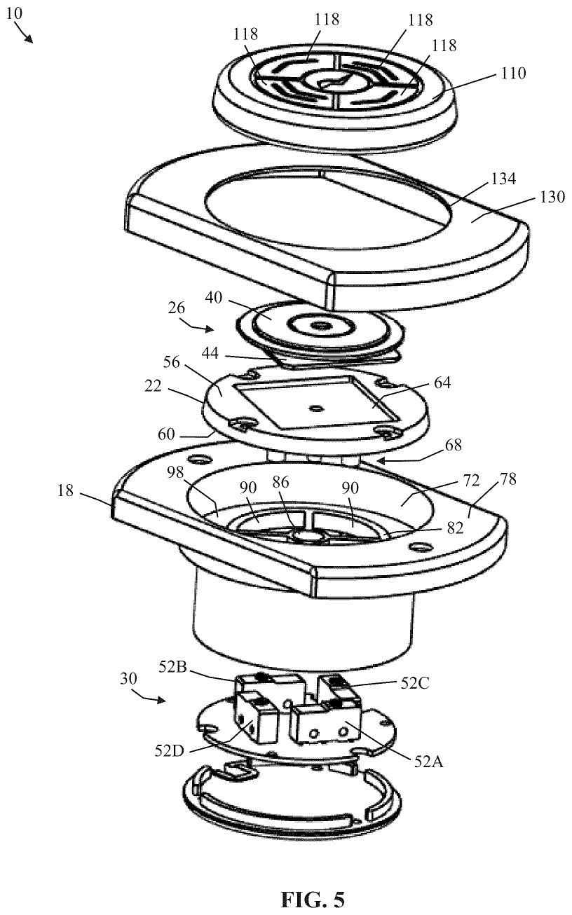

With reference to FIG. 4 and FIG. 5, the assembly 10 includes a case 18, a platform 22, a wireless charging assembly 26, and a switch assembly 30. The platform 22 is movable with respect to a center axis 34 between a first position (e.g., an at-rest position, FIG. 2) and a second position (e.g., an actuated position, FIG. 3). In some embodiments, the platform 22 is movable with respect to the center axis 34 between a plurality of positions. In the illustrated embodiment, the platform 22 is movable between at least five positions generally referable as: at-rest, up, down, left, and right. In the illustrated embodiment, the platform 22 is aligned with the center axis 34 when in the first position (e.g., at-rest).

In some embodiments, the movement of the platform 22 is deflection (e.g., elastic deformation or temporary deformation of shape that is self-reversing after removing a force or load). In other embodiments, the movement of the platform 22 is rigid body rotation such as, but not including pivoting, swiveling, rocking, wobbling, rolling, or any other suitable motion. In other words, the platform positions apart from the at-rest position, are deflected positions, rotated positions, or some combination thereof. In some embodiments, the platform 22 is made of rigid plastic.

With continued reference to FIG. 4 and FIG. 5, the wireless charging assembly 26 includes a coil 40 and a circuit board 44. In the illustrated embodiment, the wireless charging assembly 26 is coupled to the platform 22. The coil 40 defines a coil axis 48 that is aligned with the center axis 34. The wireless charging assembly 26 is configured wirelessly charge a user device (e.g., a cell phone, a laptop, a gaming controller, a gaming system, a remote, etc.), when the user device is placed on top of the assembly 10 (e.g., at the wireless charging interface 122).

With continued reference to FIG. 4 and FIG. 5, the switch assembly 30 includes a plurality of switches 52. In some embodiments, the plurality of switches 52 includes 2, 3, 4, 5, 6, or any number of suitable switches. In the illustrated embodiment, the plurality of switches includes four switches 52A, 52B, 52C, 52D spaced evenly about the axis 34. In some embodiments, the switch assembly 30 includes only a single switch. As detailed further herein, a switch is activated in response to the platform 22 moving in a direction associated with the switch. For example, the switch 52A is activated in response to the platform 22 moving to the second position (FIG. 2), which is in a “downwards” direction associated with the switch 52A. Similarly, the switch 52B is activated in response to the platform 22 moving to the third position, which is in a “upwards” direction associated with the switch 52B. In other words, the platform 22 is movable between a plurality of positions and the switches 52A, 52B, 52C, 52D are activated in response to the platform 22 moving to one of the positions.

The switches 52A-52D are configured to activate an auxiliary function of the furniture. In some embodiments, the auxiliary function activated by the switches is control of an actuator, for example, an actuator coupled to an adjustable portion of furniture. In some embodiments, the actuator is pneumatic, electric, or hydraulic. In other embodiments, the plurality of switches 52A-52D control or activate other auxiliary functions (e.g., a light source, a heat source, a massager, or another accessory). In some embodiments, the switches turn a light source on and off. In some embodiments, the switches adjust the intensity and/or color of the light source. In some embodiments, the switches turn a heat source on and off. In some embodiments, the switches adjust the intensity of the heat source. In some embodiments, the switches turn a massager on and off. In some embodiments, the switches adjust the intensity and/or pattern of the massager. The number of switches may depend on the needs of the overall system, and size of the device. These switches can be used to operate different devices, different directions on the same device, or combinations of both.

With continued reference to FIG. 5, the platform 22 includes a first surface 56 and a second surface 60, opposite the first surface 56. In the illustrated embodiment, the first surface 56 is upward-facing and circular, and the second surface 60 is downward-facing and circular. The first surface 56 and the second surface 60 are perpendicular to the axis 34 when the platform 22 is at rest (e.g., not subject to an external load or force). A recess 64 is formed in the first surface 56 of the platform 22. In the illustrated embodiment, the recess 64 at least partially receives the wireless charging assembly 26. With reference to FIG. 4, the circuit board 44 is positioned within the recess 64 of the platform 22.

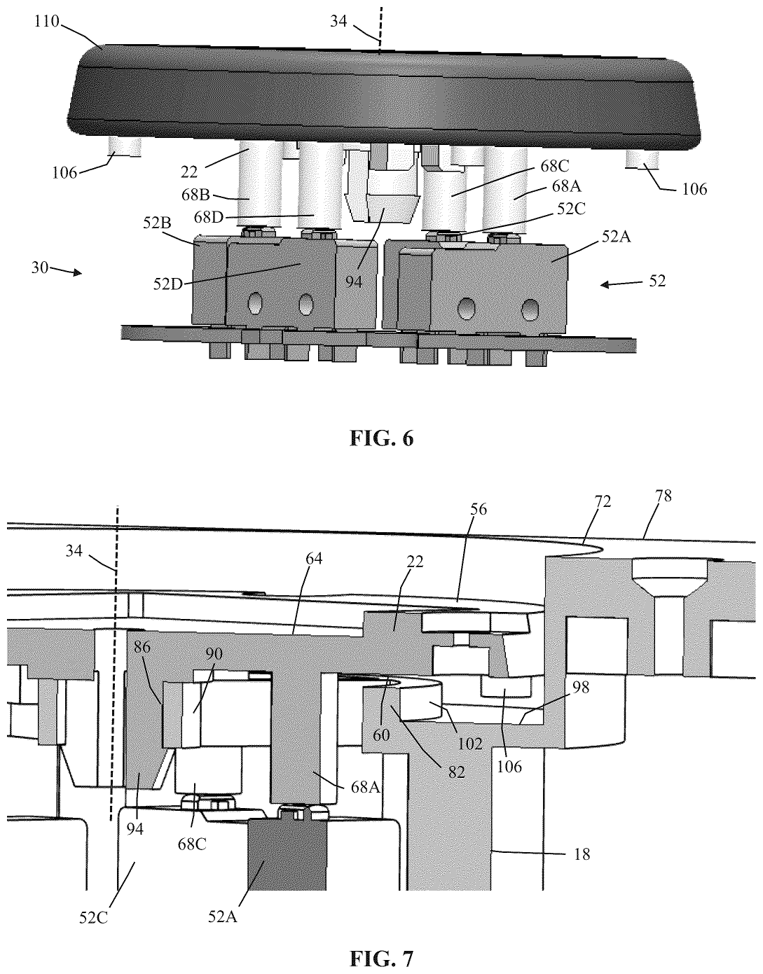

With reference to FIG. 4 and FIG. 6, a plurality of actuation portions 68 extend from the second surface 60 of the platform 22. In some embodiments, there is one actuation portion 68 for each switch in the switch assembly 30. In the illustrated embodiment, there are four actuation portions 68A, 68B, 68C, 68D associated with switches 52A, 52B, 52C, 52D, respectively. In some embodiments, there is a single actuation portion. In the illustrated embodiment, the actuation portions 68A, 68B, 68C, 68D are generally aligned with the switches 52A, 52B, 52C, 52D, respectively. For example, the actuation portion 68A is aligned with the switch 52A. In other embodiments, the actuation portions are spaced from and/or offset from the switches. In the illustrated embodiment, the actuation portions 68 are post (e.g., pegs) that extend approximately parallel to the center axis 34. In other embodiments, the actuation portion is a lever, a cam, a finger, a protrusion, or any other suitable mechanical structure configured to interact directly or indirectly with a switch.

In the illustrated embodiment, the platform 22, the wireless charging assembly 26, and the switch assembly 30 are at least partially received within the case 18. The case 18 includes a recess 72 (e.g., a groove) formed in a top surface 76. In the illustrated embodiment, the recess 72 is circular and receives the wireless charging assembly 26 and a portion of the platform 22. The recess 72 includes a center portion 82 with at least one aperture. In the illustrated embodiment, the center portion 82 includes a center aperture 86 and a plurality of apertures 90 positioned circumferentially around the center aperture 86. In the illustrated embodiment, the center aperture 86 is circular and aligned with the center axis 34. The platform 22 includes an anchor 94 (e.g., a snap-fit anchor) that is received through and coupled to the center aperture 86. In the illustrated embodiment, the anchor 94 is aligned with the center axis 34. In some embodiments, deflection of the platform 22 caused by user actuation occurs with respect to the fixed anchor 94.

With reference to FIG. 4, the actuation portions 68 extend through the apertures 90. For example, the actuation portion 68A extends through one aperture 90 and the actuation portion 68B extends through another aperture 90. As detailed herein, each of the plurality of actuation portions 68 is configured to actuate one of the plurality of switches 52.

With reference to FIG. 7, the center portion 82 is offset from a bottom surface 98 of the recess 72. In other words, the center portion 82 is raised from the bottom surface 98 and defines an inner circumferential surface 102. The platform 22 further includes a plurality of stops 106 that extend from the second surface 60. The plurality of stops 106 are configured to abut the bottom surface 98 of the recess 72 in response to deflection or movement of the platform 22. The plurality of stops 106 are positioned circumferentially around the axis 34. In the illustrated embodiment, the plurality of stops 106 are positioned radially outward from the plurality of actuation portions 68 with respect to the center axis 34. The stops 106 are formed as post (e.g., pegs) that extend approximately parallel to the actuation portions 68. In the illustrated embodiment, the stops 106 are shorter in length than the actuation portions 68.

With reference to FIG. 1, the assembly 10 further includes a button cover 110 at least partially covering the platform 22 and the wireless charging assembly 26. In the illustrated embodiment, the wireless charging assembly 26 is positioned between the platform 22 and the button cover 110. The button cover 110 provides a user interface 114. The user interface 114 includes a plurality of visual demarcations and indicia. The demarcations are formed as buttons 118 indicating where a user can depress on the user interface 114 to activate a switch and corresponding function. In the illustrated embodiment, the user interface 114 includes a wireless charging interface 122. In other words, the wireless charging interface 122 is part of the same interface manually actuated by a user for activation of the switches 52. In the illustrated embodiment, the button cover 110 includes an indicia 126 indicating the wireless charging capabilities of the assembly 10. The assembly 10 further includes a bezel 130 with an aperture 134. The bezel 130 is coupled to the case 18 and the button cover 110 is received within the aperture 134.

As detailed herein, the disclosure provides a method including (STEP 1) positioning a user device (e.g., a cell phone) on a user interface (e.g., the interface 114); (STEP 2) wirelessly charging the user device with the wireless charging assembly 26; (STEP 3) manually actuating a portion of the user interface 114 (e.g., actuating a button 118 of the user interface, FIG. 2); and (STEP 4) activating an auxiliary function of furniture in response to manually actuating the portion of the user interface. In some embodiments, activating the auxiliary function includes controlling an actuator, a light source, a heat source, a massager, or other accessory.

In some embodiments, the wirelessly charging of the user device occurs simultaneously with the manually actuating the portion of the user interface. In other words, a user is able to manually actuate a portion of the user interface while a user device is being wirelessly charged on the same user interface.

In one embodiment, the assembly 10 is integrated with a piece of furniture (e.g., a couch, a recliner, a chair, etc.). The piece of furniture includes an adjustable portion configured to move, and an actuator coupled to the adjustable portion. The assembly 10 includes the user interface 114, the wireless charging assembly 26, and at least one switch 52 to activate the actuator. In the illustrated embodiment, the user interface 114 includes a button 118 associated with the switch 52.

In conventional designs, wireless chargers are separate from switches. When switches and chargers are separate, they take up greater space and typically cost more. Conventional designs fail to address the problem of switches and chargers taking up greater space in motion furniture, for example. There is also a general teaching in the art that a charging platform should be static and is not normally considered to have a potential to be used as a moving switch. As detailed herein, the assembly 10 includes a combination of switches and wireless charging to provide an efficient and compact solution.

Various features and advantages are set forth in the following claims.

What is claimed is:

1. An assembly comprising:
a platform movable with respect to a center axis between a first position and a second position;
a wireless charging assembly coupled to the platform; and
a switch activated in response to the platform moving to the second position.

2. The assembly of claim 1, wherein the wireless charging assembly is configured to wirelessly charge a device; and wherein the switch is configured to activate an auxiliary function.

3. The assembly of claim 1, wherein the first position is an at-rest position, and the second position is a deflected or rotated position.

4. The assembly of claim 1, wherein the platform is aligned with the center axis when in the first position.

5. The assembly of claim 1, wherein the platform including a first surface and a recess formed in the first surface that partially receives the wireless charging assembly.

6. The assembly of claim 5, wherein the platform includes a second surface with an actuation portion extending from the second surface, the actuation portion is aligned with the switch.

7. The assembly of claim 6, further including a case, wherein the platform, the wireless charging assembly, and the switch are at least partially received within the case.

8. The assembly of claim 7, wherein the case includes a recess formed in a top surface, and an aperture formed in the recess, wherein the actuation portion extends through the aperture.

9. The assembly of claim 1, wherein the platform is movable with respect to the center axis between the first position, the second position, and a third position, and wherein the switch is a first switch, and the assembly further includes a second switch, and the second switch is activated by the platform in response to the platform moving to the third position.

10. The assembly of claim 1, further including a button cover at least partially covering the platform and the wireless charging assembly.

11. An assembly comprising:
a case including a recess formed in a top surface, the recess includes a plurality of apertures;
a platform including a plurality of actuation portions, wherein the plurality of actuation portions extend through the plurality of apertures;
a wireless charging assembly coupled to the platform, and
a switch assembly including a plurality of switches, wherein each of the plurality of actuation portions is configured to actuate one of the plurality of switches.

12. The assembly of claim 11, wherein the wireless charging assembly includes a coil and a circuit board.

13. The assembly of claim 11, further including a button cover, wherein the wireless charging assembly is positioned between the platform and the button cover.

14. The assembly of claim 13, further including a bezel with an aperture, wherein the bezel is coupled to the case, and the button cover is received within the aperture.

15. The assembly of claim 11, wherein the platform includes a first surface and a second surface opposite the first surface, wherein the first surface includes a recess formed that partially receives the wireless charging assembly, and wherein the plurality of actuation portions extends from the second surface.

16. The assembly of claim 15, wherein the platform further includes a stop extending from the second surface, wherein the stop is configured to abut a surface of the recess in response to deflection or movement of the platform.

17. The assembly of claim 16, wherein the stop is positioned radially outward from the plurality of actuation portions.

18. The assembly of claim 11, wherein the recess of the case includes a center portion with a center aperture, and the plurality of apertures are spaced around the center aperture.

19. The assembly of claim 18, wherein the platform includes an anchor received through and coupled to the center aperture.

20. The assembly of claim 19, wherein the platform is movable between a plurality of positions, wherein each of the plurality of switches is activated in response to the platform moving to one of the plurality of positions.

21. A piece of furniture comprising:
an adjustable portion configured to move;
an actuator coupled to the adjustable portion;
an assembly including a user interface, a wireless charging assembly, and a switch to activate the actuator.

22. The piece of furniture of claim 21, wherein the user interface includes a button associated with the switch, and wherein the user interface includes a wireless charging interface.

23. A method comprising:
positioning a user device on a user interface;
wirelessly charging the user device;
manually actuating a portion of the user interface; and
activating an auxiliary function of furniture in response to manually actuating the portion of the user interface.

24. The method of claim 23, wherein activating the auxiliary function includes controlling an actuator, a light source, a heat source, or a massager.

25. The method of claim 23, wherein wirelessly charging the user device occurs simultaneously with manually actuating the portion of the user interface.
